(19) United States
(12) Patent Application Publication
(10) Pub. No.: US 2011/0028035 A1
(43) Pub. Date: Feb. 3, 2011

(54) WALL PLATE HAVING INTEGRATED CATV SIGNAL-SPLITTER

(76) Inventor: Michael J. McAllister, Malvern, PA (US)

Correspondence Address: Michael J. McAllister, 3 Shady Brook Lane, Malvern, PA, 19355-2154, US

(21) Appl. No.: 12/510,515

(22) Filed: Jul. 28, 2009

(51) Int. Cl. H01R 9/05

(52) U.S. Cl. 439/579

(57) ABSTRACT

An electrical wall plate (1, 10) with integrated coaxial cable television [CATV] signal-splitter (7) therein that while providing a shared CATV signal, helps to preserve the integrity and strength of the incoming CATV cable (6) signal, speeds installation and obviates the existing art's requirements of connector coaxial cables and downstream CATV signal-splitter.

### BACKGROUND OF THE DISCLOSURE

The disclosure generally relates to a device that is an electrical wall plate having incorporated therein a coaxial cable television [CATV] signal-splitting assembly commonly known as a “signal-splitter.” Said device helps maintain original CATV signal strength, eliminates certain coaxial cables, simplifies and speeds connections and installations and reduces wire and cable disorganization and clutter.

As basic “F-type” connections involved in CATV exhibit very low voltage, there is virtually no risk of electrical shock. So, home improvement enthusiasts, do-it-yourselfers, computer users, and professional installers often use CATV signal-splitters.

Originally used to share a CATV signal, so two or more televisions could use it simultaneously, the conventional CATV signal-splitter has more recently also become the de facto means of accommodating a demand for high speed cable Internet access. Today, CATV signal-splitters are being widely used in homes and offices so CATV service can be shared between cable television and cable Internet access. A signal-splitter can provide two or more access points from a single incoming CATV cable. This sharing of the paid CATV service is like having two or more incoming cables for the price of one.

However, excessive sharing or splitting of a CATV signal degrades both the cable television service and cable Internet access. There is an “insertion loss” of incoming signal strength of as much as five decibels per CATV connection. So, to mitigate the deleterious effects that too many connections will cause, it is professionally advised that the number of connections made to a single incoming CATV signal be minimized. Yet, a minimum of six to eight connections to an incoming cable carrying the original CATV signal is typically required.

Here is how a single direct connection (no signal-splitter used) to a standard CATV wall plate, is set up. The incoming cable is generally located within or running along a wall in a dwelling or room therein and is connected to the “back” of a standard CATV wall plate. The “pass-through” wall plate of the existing art simply allows a signal to continue through a wall plate. Through a CATV cable connected to the wall plate's opposite side and to a single piece of CATV-ready equipment (e.g. a television or personal computer modem), the CATV signal is ultimately delivered. CATV cable service is thereby provided; no further connections are necessary.

However, two or more televisions or two or more personal computers or a combination thereof, can effectively share an incoming CATV signal through the use of a CATV signal-splitter which divides the CATV signal. This way, all the CATV-ready equipment shares one incoming CATV signal without the expense of additional cabling and additional cable service. Absent the device of the present disclosure, however, in order to effect this CATV signal sharing, at least six or eight CATV connections are required and that is excessive.

Let's examine the widely implemented method that causes the minimum six connections. By following the original CATV signal from its source, the incoming CATV cable connected at the wall plate, the connections can be thusly enumerated (no. 1, no. 2, etc.) for clarity:

On the “front” or facing engagement of the surface plane of the wall plate, in a dwelling or room, the first of the six connections is made with a “connector” coaxial cable (connection no. 1). This connector cable, while obviated by the device of the present disclosure, is required by the popular method of the existing art to connect the CATV wall plate to a signal-splitter (no. 2), downstream of the wall plate.

Then, there are two connections made at one end of two cables (no. 3 and no. 4), each attached to a CATV signal-splitter and finally, two more connections made at the opposite end of those two cables (no. 5 and no. 6) where they are ultimately attached to the CATV-ready equipment. Using the existing art, where one desires to split a CATV signal, there will total a minimum of these six connections.

In view of the present disclosure, the popular method in this example requires an excessive number of connections which represents, among other things, a loss of signal strength. Thirty-three percent of these connections can be eliminated by use of the device of the present disclosure. Less connections helps preserve the strength of the original CATV signal and simplifies installation.

Highlighting an important difference between the device of the present disclosure and the existing art, the latter requires at least one connector coaxial cable between the CATV pass-through wall plate and the signal-splitter. This cable is required to simply connect the wall plate to the signal-splitter. In the aforementioned example of a popular method to split a CATV signal, it should be noted the existing art has the additional coaxial cable and signal-splitter generally located on the floor. This presents a wire and cable management issue.

In contrast, such connector cable and downstream signal-splitter are completely unnecessary with use of the device of the present disclosure and are thus eliminated. Such device provides a CATV wall plate that does not require additional connector cable(s) or a signal-splitter downstream of the wall plate. It achieves the signal-splitting in the wall plate. The economies introduced, therefore, are many.

The device of the present disclosure helps preserve the integrity and strength of the original CATV signal. It simplifies and speeds CATV connections and installations while obviating any connector coaxial cable(s), cutting expense and reducing wire and cable disorganization and clutter.

### SUMMARY OF THE DISCLOSURE

Accordingly, the disclosure is directed to a device comprising an electrical wall plate and integrated coaxial cable television [CATV] signal-splitting assembly. The device eliminates 33% to 50% of the typical minimum connections required by the existing art. This economy helps preserve the integrity and strength of the incoming CATV signal while providing convenient and faster installations that can share the CATV signal between cable television service and personal computer Internet access service.

By the use of the device of the present disclosure, the coaxial cable carrying the original incoming CATV signal is directly attached to the CATV signal-splitter in the wall plate. Therein, the CATV signal is simultaneously divided into two or more paths and conveyed by cable(s) to CATV-ready equipment. By having the CATV signal-splitter integrated within the wall plate as one device, the signal-splitter is hidden from sight and protected from physical compromise, the cost and installation of connector coaxial cable(s) are obviated, and there is no CATV signal-splitter downstream of the wall plate as in the existing art. The efficiencies in the whole process are greatly enhanced.

In other embodiments, the wall plate with integrated CATV signal-splitter may include an optional member mechanically attached to its facing engagement surface plane that would fully enclose the CATV connections on the wall plate device adjacent thereto.

The device of the present disclosure may be constructed of materials, including metal and plastic, which are formed, molded, stamped, welded, glued and otherwise assembled.

### BRIEF DESCRIPTION OF THE FIGURES

Other objects and advantages of the present disclosure will become apparent from a study of the following specification when viewed in light of the accompanying drawings, in which:

FIGS. 1a and 3a are full views of the “front” or facing engagement surface of the device of the present disclosure, a CATV electrical wall plate in which a CATV signal-splitter is incorporated to divide or split an incoming CATV signal.

FIGS. 1b and 3b are side plans of the device of the present disclosure which comprises an electrical CATV wall plate with a CATV signal-splitter integrated therein. For orientation, the CATV cables that would convey the CATV signal to CATV-ready equipment such as a television and a personal computer modem are shown.

FIGS. 1c and 3c are full views of the “front” or facing engagement surface of the device of the present disclosure, restricting the view to the base plane CATV electrical wall plate in which a CATV signal-splitter is incorporated to divide or split an incoming CATV signal.

FIG. 1d is an angle view of the base plane CATV electrical wall plate in which a CATV signal-splitter is incorporated, to divide or split an incoming CATV signal, and showing for perspective the wall box or junction box wall opening.

FIG. 2a [a prior art example] is a frontal view of the facing engagement surface of an existing widely distributed standard CATV wall plate, herein referred to as a pass-through wall plate. It is the centerpiece of the popular method of the existing art. When it is preferred that the CATV signal be shared, this method requires, at minimum, an extra coaxial cable (not shown), a signal-splitter (not shown), two or more excessive CATV signal-draining connections (not shown) and additional installation complexity and time.

FIG. 2b [a prior art example] is a side plan of the existing pass-through CATV wall plate that simply conveys the CATV signal through the wall plate, through a wall or other surface (not shown), and on to CATV-ready equipment.

### DETAILED DESCRIPTION OF THE DISCLOSURE

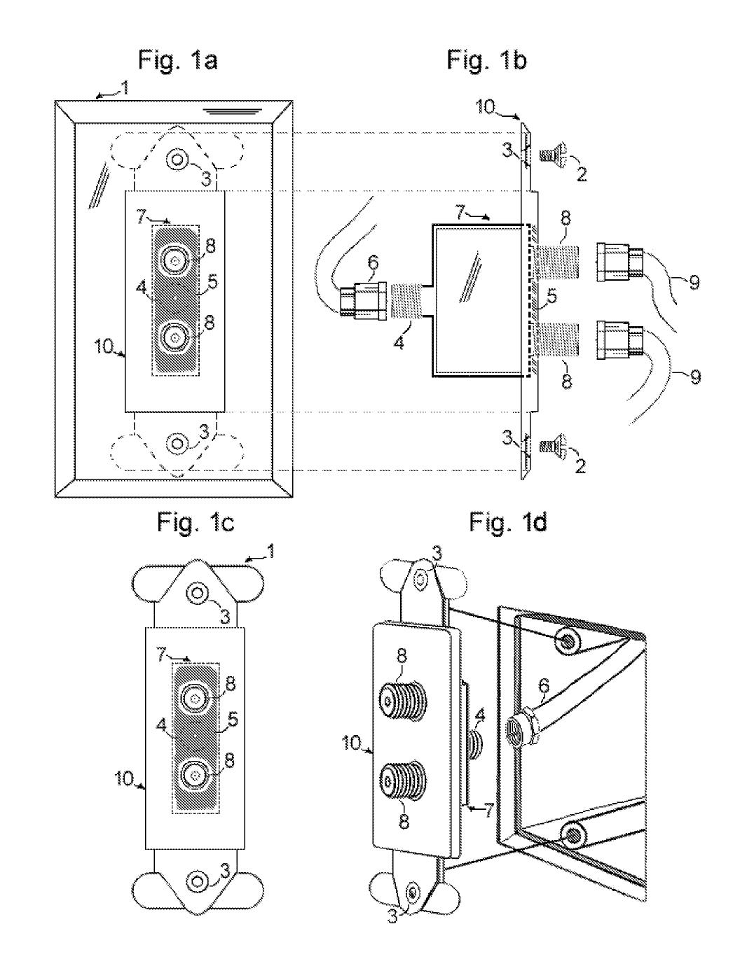

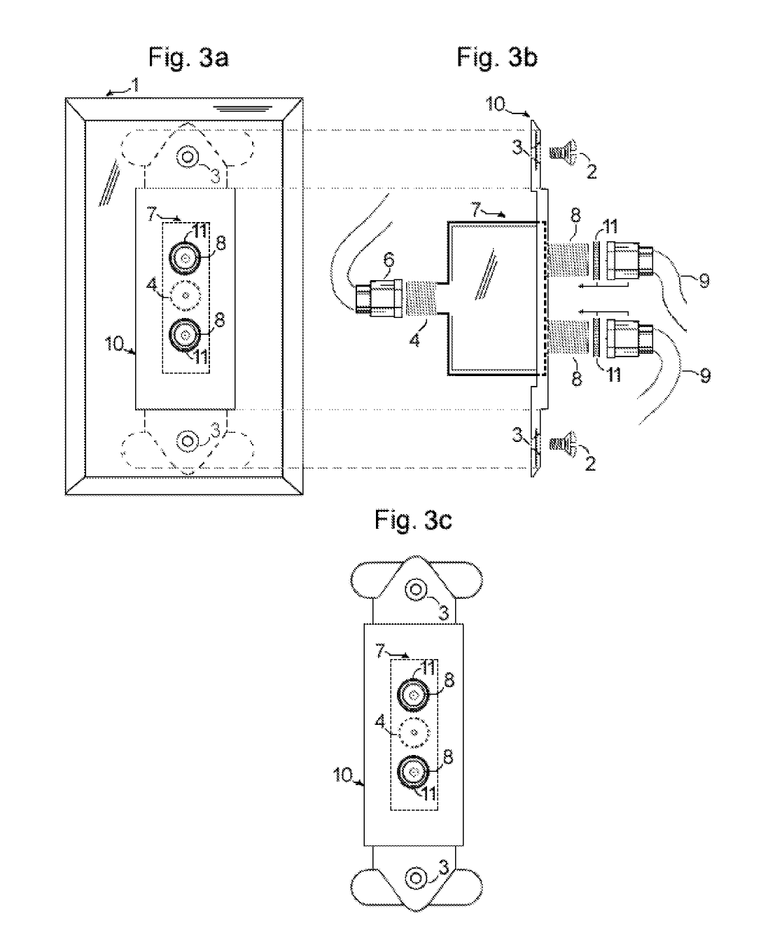

Referring to the drawings, FIGS. 1a, 1c and 3a, 3c exhibit frontal views of the facing engagement surface, the “front,” of the device of the present disclosure. A single incoming coaxial cable television [CATV] connection occurs at 4, behind the proximate center of the CATV wall plate, to a CATV signal-splitter 7 on the opposite side of the facing engagement surface of the CATV wall plate 1, 10. The dividing of the CATV signal occurs within the signal-splitter 7 at the wall plate 1, 10. This is also where the CATV signal is conveyed through two outgoing connections 8 of the device. Two screw holes 3 allow screws 2 to fix the CATV wall plate 1, 10 to a wall or other surface typically bearing a CATV cable within it or behind it.

Referring to FIGS. 1b and 3b of the drawings, side plan views of the device of the present disclosure are shown, comprising an electrical wall plate 1, 10 having an integrated CATV signal-splitter 7. For orientation to the drawing, CATV cables 6 and 9 are depicted, though not components of the device of the present disclosure. A base plane 10, fully attachable to a surface or attachment plane 1, of the device of the present disclosure, is shown. This base plane has a CATV signal-splitter incorporated therein to divide or split an incoming CATV signal.

A single CATV connection 4 is shown in the proximate center of the opposite side of the facing engagement surface, on the “back,” of the wall plate 1, 10 where an incoming CATV cable 6 is on or within a wall or on another surface and connects to the integrated CATV signal-splitter 7. That signal-splitter 7 is shown incorporated by adhesive means 5, on the opposite side of the facing engagement surface, the “back,” of the base plane 10 attached to wall plate 1, 10 or by mechanical threaded screw components 11 so that the signal-splitter is within and forward of, and also behind and opposite, the facing engagement surface of wall plate 1. While there is a variety of mechanical means, such as threaded screw components, snap-fit arrangements and others, by which the signal-splitter 7 can be incorporated, they are not all depicted here. The device of the present disclosure can divide or split the incoming CATV signal so it may be shared. The shared CATV signal is conveyed through two CATV connections 8 of the CATV signal-splitter 7, to two CATV cables 9. The wall plate 1, 10 of the device of the present disclosure offers a minimum of two CATV connections 8, to which coaxial cables 9 may be connected, to thereby directly provide the CATV signal to CATV-ready equipment such as a television and personal computer modem (not shown). The wall plate 1, 10 is typically fixed to a wall or other surface by the use of the two screws 2, installed through the two screw holes 3, both of which are generally provided with the wall plate 1, 10.

From the descriptions above, a number of advantages of some embodiments of the device of the present disclosure become evident. The more significant of these are enumerated here:
(1) 33% to 50% less connections to the original incoming CATV cable 6 are needed, so less time is required for installation.
(2) Original CATV signal strength is less affected thereby improving CATV service.
(3) The cost and installation of an entire coaxial cable (the “connector” cable) is eliminated which reduces expense.
(4) Installation is simplified.
(5) This wall plate 1, 10 having an integrated CATV signal-splitter which obviates connector cable(s) and a signal-splitter downstream of the wall plate 1, 10 eliminates a wire and cable management issue of the existing art.

FIG. 1d provides the perspective of an angle view depicting the base plane CATV electrical wall plate with CATV signal-splitter incorporated therethrough, to divide or split an incoming CATV signal. The wall box or junction box wall opening is included for clarity of intended purpose, however, the wall box or junction box wall opening is not a part of the device of the present disclosure.

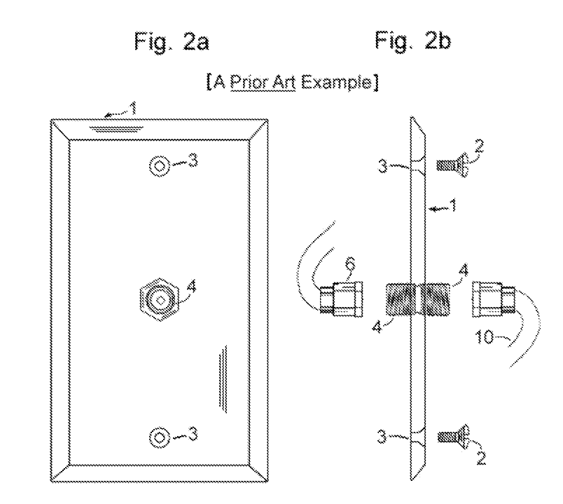

Referring to FIG. 2a of the drawings, a prior art example is provided for clarity of the disclosure. Depicted is a frontal view of a standard pass-through CATV wall plate 1. The wall plate 1 is used to provide a CATV signal at a point of accessibility. The signal comes from via a CATV cable 6, connected behind the facing engagement surface of the wall plate 1 at connection 4, which is attached to wall plate 1. Primarily used for aesthetic purposes, the wall plate 1 may also cover an asymmetrical hole in a wall to provide privacy, a barrier to intrusion by insects and other pests, and insulation against leakage of heated and cooled air.

Referring to FIG. 2b of the drawings, the side plan of a prior art example shows the standard pass-through wall plate 1 exhibiting the basic “type F” CATV cable connections 4, identical on both its ends and mechanically inserted into the center of wall plate 1. An incoming CATV cable 6 is shown ready to attach to a connection 4 on the opposite side of the facing engagement surface. No dividing or splitting of the CATV signal occurs in this standard CATV wall plate 1 of the existing art. Rather, the signal merely passes through the wall plate 1 via the type F connections 4. The incoming CATV signal passes from the wall plate 1 via a CATV cable 10 connected to a connection 4 of the facing engagement surface of wall plate 1 and to a CATV-ready television or personal computer modem (not shown) at the opposite end of CATV cable 10. The screws 2 are used to fix the CATV wall plate 1 to a wall or other surface through the screw holes 3, both of which are generally provided with the wall plate 1.

Accordingly, in contrast to the existing art, use of the device of the present disclosure reduces connections thirty-three to fifty percent. This is especially significant because some of its further advantages are derived from this initial advantage: Fewer required connections mean the original CATV signal strength is less deleteriously affected, thereby improving CATV service. Fewer connections also result in less complicated and faster installations. And, the expense and installation of at least one connector coaxial cable is eliminated which, along with the aforementioned, reduce costs. Not to be overlooked by many who enjoy personal computers today, the fact that the device of the present disclosure will also reduce wire and cable disorganization and clutter, because it has an integrated CATV signal-splitter and no connector cable, is also an important advantage over the existing art.

The foregoing is given by way of illustration, and not limitation. Variations on these will occur to those skilled in the art, and are not meant to be excluded from the scope of the claims that follow.

What is claimed is:

1. A wall plate having an integrated coaxial cable television [CATV] signal-splitter assembly comprising:
a base plane, fully attachable to a surface or attachment plane, having incorporated in it by mechanical or adhesive means, at least one CATV signal-splitting member affixed therethrough which may divide and convey electronic analog and/or digital signal(s), wherein;
a CATV signal-splitting member accommodates at least one incoming coaxial cable signal connection and provides at least two outgoing coaxial signal cable connections.

2. The device of claim 1 wherein the wall plate generally conforms to the topology of the surface or attachment plane to which it may be affixed.

4. A wall plate formed of plastic, metal, wood or a composite of any two or all three of these, having an integrated coaxial cable television [CATV] signal-splitter assembly accommodating at least one incoming coaxial cable signal connection and at least two and not more than four outgoing coaxial signal cable connections, wherein:
the “base plane” wall plate is not wider than one and one-half inches (1½″) nor narrower than one and one-quarter inches (1¼″) and not longer than four and one-eighth inches (4⅛″) nor shorter than three and seven-eighths inches (3⅞″), and
said wall plate being generally much narrower than a standard North American construction industry wall box or junction box wall opening and incapable of covering said wall box or junction box wall opening and being, optionally, fully attachable to a surface or attachment plane formed of plastic, metal, wood or plaster board, and
said wall plate having incorporated in it, by permanent mechanical or semi-permanent adhesive means, at least one CATV signal-splitting member whose multiple F-connector side is affixed therethrough to divide and convey electronic analog and/or digital signals.

5. A device of the combination of two elements: wall plate and CATV signal-splitter, wherein said wall plate exhibits at least two and not more than four holes, each being not more than one-half (½″) inch in diameter nor less than one-quarter inch (¼″) in diameter, whose centers are situated no closer to each other than one-half inch (½″) nor separated by no more than one and one-quarter inch (1¼″), and which are longitudinally aligned on the face of said wall plate, accommodating the multiple F-connector side of a signal-splitter permanently affixed to said wall plate by adhesive means, and
said adhesive applied on the side of the CATV signal-splitter bearing multiple F-connectors or applied on the underside surface of the wall plate or both and the two elements of this combination physically abutted so that the multiple F-connectors permanently protrude through the, at least, two and not more than four accordingly aligned holes of said wall plate. The adhesive permanently secures the signal-splitter to the wall plate.

6. The device of claim 5 wherein the wall plate is injection molded of thermoplastic resin or compound, using a mold to impart the at least two and not more than four accordingly aligned holes.

7. The device of claim 5 wherein the wall plate is compression molded of thermoset plastic resin or fiber-reinforced thermoset plastic, whereby a compression mold is used to impart the at least two and not more than four accordingly aligned holes.

8. The device of claim 5 wherein the wall plate is injection molded of thermoplastic resin or compound and a post-molding stamping process is used to impart the at least two and not more than four accordingly aligned holes.

9. The device of claim 5 wherein the wall plate is injection molded of thermoset plastic resin or fiber-reinforced thermoset plastic and a post-molding stamping process is used to impart the at least two and not more than four accordingly aligned holes.

10. A device of the combination of two elements: wall plate and CATV signal-splitter, wherein said wall plate exhibits at least two and not more than four holes, each being not more than one-half inch in diameter nor less than one-quarter inch in diameter, whose centers are situated no closer to each other than one-half inch nor further apart than one and one-quarter inch, and which are longitudinally aligned on the face of said wall plate accommodating the signal-splitter, semi-permanently affixed to said wall plate by means of two, three or four, as the case may be, identical internally threaded screw rings, formed to screw onto the F-connectors of the multiple F-connector side of the CATV signal-splitter, each not more than one-half inch (½″) in diameter nor less than one-quarter inch (¼″) in diameter and not more than one-eighth inch (⅛″) tall. The threaded screw rings are applied once the two elements of the combination are physically abutted causing the multiple F-connectors to protrude through the two, three or four accordingly aligned holes of said wall plate. The thread on the inside diameter of the threaded screw rings engages and interlocks with the threads on the outside diameter of the protruding F-connectors to secure the signal-splitter to the wall plate.

11. The device of claim 10 wherein the wall plate is injection molded of thermoplastic resin or compound, using a mold to impart the at least two and not more than four accordingly aligned holes.

12. The device of claim 10 wherein the wall plate is compression molded of thermoset plastic resin or fiber-reinforced thermoset plastic, whereby a compression mold is used to impart the at least two and not more than four accordingly aligned holes.

13. The device of claim 10 wherein the wall plate is injection molded of thermoplastic resin or compound and a post-molding stamping process is used to impart the at least two and not more than four accordingly aligned holes.

14. The device of claim 10 wherein the wall plate is injection molded of thermoset plastic resin or fiber-reinforced thermoset plastic and a post-molding stamping process is used to impart the at least two and not more than four accordingly aligned holes.

15. A device of the combination of two elements: wall plate and CATV signal-splitter, wherein said wall plate is molded in size of not more than two inches (2″) by four inches (4″) so it may be attached to a wall box or junction box wall opening but be unable to cover same, thereby allowing cables not attached to said device to exit through the sides of the peripheral area around it. Said wall plate exhibiting:
at least two and not more than four holes, each not more than one-half inch (½″) nor less than one-quarter inch (¼″) in diameter, whose centers are situated no closer to each other than one-half inch (½″) nor further apart than one and one-quarter inch (1¼″), longitudinally aligned on the face of said wall plate accommodating the affixed signal-splitter.

16. The device of claim 15 wherein the wall plate is injection molded of thermoplastic resin or compound, using a mold to impart the at least two and not more than four accordingly aligned holes.

17. The device of claim 15 wherein the wall plate is compression molded of thermoset plastic resin or fiber-reinforced thermoset plastic, whereby a compression mold is used to impart the at least two and not more than four accordingly aligned holes.

18. The device of claim 15 wherein the wall plate is injection molded of thermoplastic resin or compound and a post-molding stamping process is used to impart the at least two and not more than four accordingly aligned holes.

19. The device of claim 15 wherein the wall plate is injection molded of thermoset plastic resin or fiber-reinforced thermoset plastic and a post-molding stamping process is used to impart the at least two and not more than four accordingly aligned holes.
